(19) United States
(12) Patent Application Publication
(10) Pub. No.: US 2026/0168438 A1
(43) Pub. Date: Jun. 18, 2026

(54) TURBINE RECOUPERATOR

(71) Applicant: Enrique J. Enriquez, Miami, FL (US)

(72) Inventor: Enrique J. Enriquez, Miami, FL (US)

(21) Appl. No.: 18/986,542

(22) Filed: Dec. 18, 2024

(51) Int. Cl. F02C 7/10

(52) U.S. Cl. CPC F02C 7/10

(57) ABSTRACT

A turbine recouperator includes an air flow path having an air inlet upstream of a combustor chamber of a turbine. An outlet of the air flow path delivers air into the combustor chamber. At least a portion of the air flow path is disposed relative to the combustor chamber such that heat is transferred from the combustor chamber to at least a portion of the air flow path to preheat the air before entering the combustor chamber. Heat may be transferred to the air flow path through the wall defining the air flow path, as well as through projections extending into the air flow path.

### FIELD OF THE INVENTION

The present invention generally relates to turbines. More particularly, the present invention relates to an improved recuperator for use with turbines.

### BACKGROUND OF THE INVENTION

A turbine is a rotary mechanical device that extracts energy from a fluid flow, such as water, steam, air or combustion gases, and converts it into useful work. The combustor section is a core part of the turbine where a mixture of compressed air and fuel gets ignited by an ignition device, therefore creating a combustion reaction. Turbines are generally used in electrical generation, engines and propulsion systems.

Recuperators are used to recover waste heat from exhaust gases at medium to high temperatures to preheat air required on board, hence decreasing the energy demand. In the context of a turbine, a turbine recuperator is a heat exchanger that recovers waste heat from a turbine's exhaust to preheat the compressed air before it enters the combustion chamber. Recuperators are important in high temperature applications and when the heat source has a high minimum temperature.

If done properly, theoretical efficiency improvements of the system by up to 20% are possible over a wide operating range. Moreover, a recuperator can reduce fuel consumption.

In the case of turbines, and particularly for use with micro turbine generators, conventional recuperators utilize a finned heat exchanger included in the shroud on the exhaust side of the combustor to preheat the air intake to the combustor chamber. However, such exhaust-side heat exchanger increases the back pressure on the exhaust, thus reducing power output. Moreover, such conventional exhaust-side recuperators add weight to the turbine generator and increases construction costs.

Accordingly, there is a continuing need for an improved recuperator which overcomes the disadvantages and shortcomings of conventional recuperators, including avoiding increases in back pressure on the exhaust, and reducing power output of the turbine generator. The present invention fulfills these needs and provides other related advantages.

### SUMMARY OF THE INVENTION

The present invention resides in an improved turbine recuperator which is disposed upstream of the turbine combustor to avoid exhaust-side increases in back pressure on the exhaust and the resulting reduced power output.

The turbine recuperator generally comprises an air flow path having an air inlet at a first end thereof upstream of a combustor chamber of a turbine and an outlet at a second end for delivering air into the combustor chamber. At least a portion of the air flow path is disposed relative to the combustor chamber such that heat is transferred from the combustor chamber to at least a portion of the air flow path to preheat the air before entering the combustor chamber. Due to its arrangement, heat from the combustor chamber is conductively transferred to the air flow path.

The air flow path between the air inlet and the air outlet may be tortuous. For example, the air flow path between the air inlet and the air outlet may have a serpentine configuration.

A wall at least partially defines the air flow path. The wall may be disposed adjacent to the combustor chamber. The wall may form at least a portion of the combustor chamber and define the air flow path.

A plurality of projections, such as a lattice work, may extend into the air flow path, such as from an inner surface of the wall, to facilitate heat transfer from the combustor chamber to the air flowing through the air flow path.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a side perspective view of a turbine incorporating a recuperator of the present invention;

FIG. 2 is a partial cross-sectional view taken generally along lines 2-2 of FIG. 1;

FIG. 3 is a diagrammatic sectional view illustrating flow of air through the recuperator and into a combustor of the turbine, in accordance with the present invention; and

FIG. 4 is a cross-sectional view of a combined recuperator and combustor, used in accordance with the present invention.

### DETAILED DESCRIPTION OF THE PREFERRED EMBODIMENTS

As shown in the accompanying drawings, for purposes of illustration, the present invention resides in an improved recuperator for use with turbines, and particularly micro turbine generators and the like. As described below, the recuperator of the present invention is designed and configured so as to absorb heat directly from the combustor of the turbine, rather than exhaust gases, and thus does not interfere with exhaust flow.

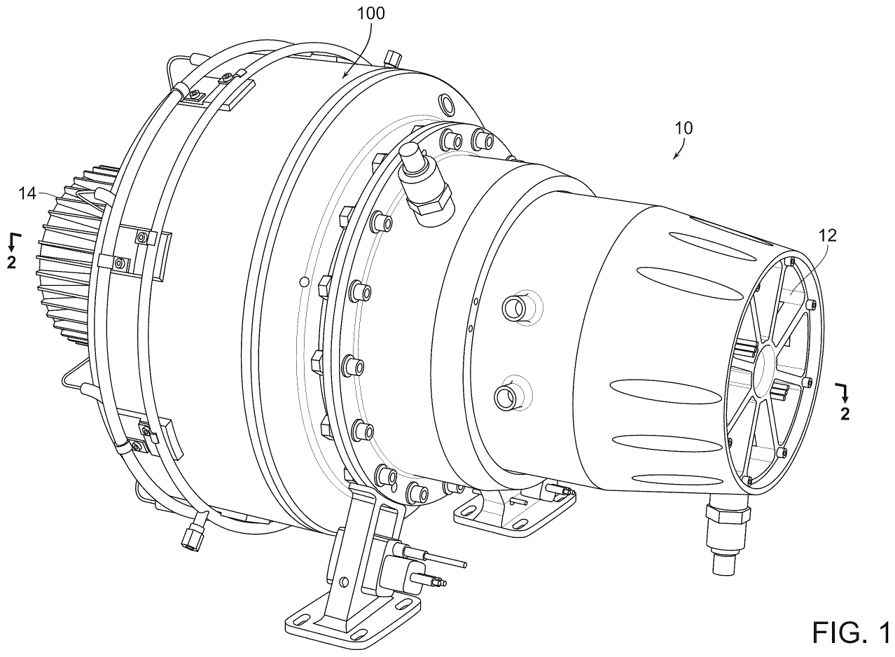

With reference now to FIG. 1, an exemplary turbine 10 is illustrated. The turbine 10 may comprise a micro turbine generator or the like. The turbine can include an air or other fluid inlet 12 and an exhaust outlet 14. The air inlet 12 may be an inlet to a compressor, as is known. Intermediate the air inlet 12 and exhaust outlet 14 is a combustion chamber or combustor. A recuperator 100 is incorporated into the turbine 10. The recuperator 100 may be comprised of a combination recuperator and combustor having a combustion chamber. The recuperator and/or combined recuperator and combustor 100 may be detachably connected to the turbine 10 or integrally formed therewith.

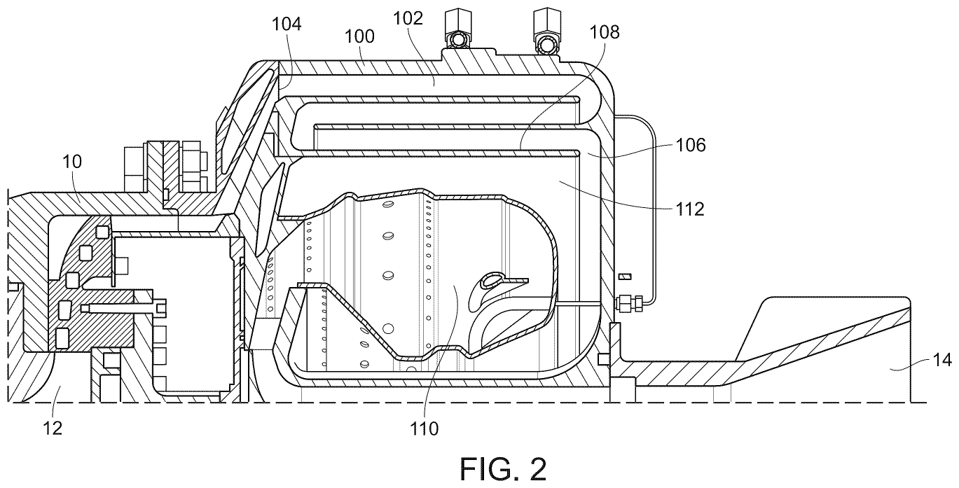

With reference now to FIG. 2, a cross-sectional view of an exemplary recuperator and combustor 100 is shown. The recuperator 100 comprises an air flow path 102 having an air inlet 104 at a first end thereof and an outlet 106 at a second end thereof. Preferably, the air flow path between the air inlet and the air outlet is tortuous. The air flow path 102 may have a serpentine configuration, as illustrated. A wall 108, or multiple walls, may at least partially define the air flow path 102.

With reference to FIGS. 2-4, the air inlet 104 of the recuperator, and more particularly the air flow path 102 is upstream of a combustor chamber 110 of the turbine. The outlet 106 at the generally opposite end of the air flow path delivers air into the combustor chamber, which may be by means of an intermediate chamber 112. Because the walls of the combustor chamber 110 are constructed with ports and openings as shown in FIGS. 2-4, heat and fluids flow freely between the combustor chamber 110 and the intermediate chamber 112, such that the intermediate chamber 112 is an extension of the combustor chamber 110 and at the same temperature thereof. Alternatively, the outlet 106 delivers air directly into the combustor chamber 110.

The air flow path 102 is disposed relative to the combustor chamber 110 such that heat is transferred from the combustor chamber to at least a portion of the air flow path to preheat the air passing therethrough before entering the combustor chamber 110. Typically, the heat from the combustor chamber 110 is conductively transferred to the air flow path 102. This is typically by means of the heat being conductively transferred through the wall 108 defining the air flow path, which may be disposed adjacent to the combustor chamber 110. The wall 108 may form at least a portion of the combustor chamber and define the air flow path. Thus, as a mixture of fuel and air is ignited in the combustor chamber 110, the heat generated thereby is transferred from the wall 108 to the air flow path 102, and thus the air passing through the air flow path.

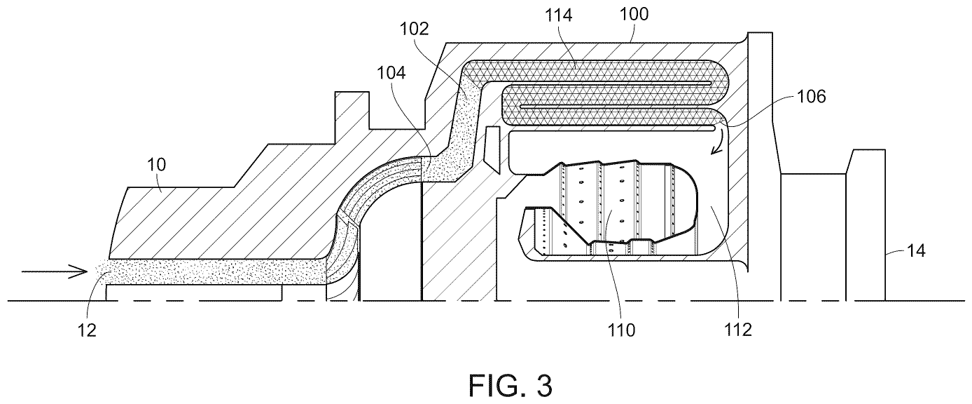

With particular reference now to FIG. 3, air may enter through air inlets 12 of the turbine 10 and be moved into the air inlet 104 of the air passageway 102, and pass through the air flow path 102 to the outlet 106, which delivers the air into the combustor chamber 110. As the air flows through the air flow path 102, the heat transferred from the ignition of the air fuel mixture within the combustor chamber 110 is transferred to the air flow pathway 102, such as by means of being conductively transferred through the wall 108 defining the air flow path 102, such that the air being delivered from outlet 106 is preheated, which provides efficiency benefits to the turbine 10. As described above, the wall 108 may be disposed adjacent to the combustor chamber 110, or even formed at least as a portion of the combustor chamber 110, such as when the recuperator 100 and combustor chamber 110 are formed as a single unit, as illustrated herein.

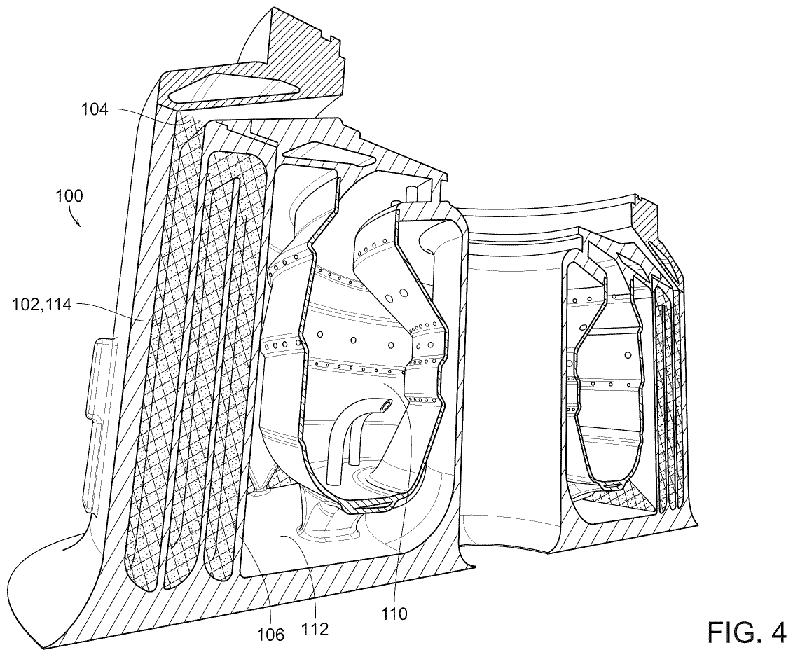

With reference now to FIGS. 3 and 4, in order to facilitate heat transfer from the combustor chamber 110 to the air flowing through the air flow path 102, a plurality of projections 114 may extend into the air flow path along at least a portion of the length of the air flow path 102. Preferably, as illustrated, the projections 114 extend from the inner surface of the wall 108 defining the air flow path 102 along substantially a length of the air flow path 102. The projections 114 may comprise a lattice work.

The wall 108 and projections 114 are preferably comprised of a heat conductive material, such as a metal, which can effectively transfer heat from the heat generated by the combustor chamber 110 to the air flowing through the air flow path 102. As the air comes into contact with the wall 108 and/or the projections 114 extending into the air flow path 102, heat is transferred to the air. The projections or lattice work 114 serve to increase the surface area for heat exchange with the air passing through the air flow path 102.

Typically, the housing, walls, case, etc. defining the combustor chamber 110 and air flow path 102 are comprised of a metal or metal alloy which are capable of conducting heat. Such may be a metal-super alloy. In one particular embodiment, the combustor chamber and recuperator 100 can be 3D printed as a single piece using printable metal, such as a metal-super alloy, such as Inconel-718, or the like. The serpentine air intake flow path 102, with integrated projections or lattice work 114, may be formed using 3D printing techniques.

Designing and configuring the air flow path 102 to be built adjacent to or into the wall of the combustor chamber 100/110, such that the inlet 104, and the air flow path 102 are upstream of the combustor chamber 110 results in the recuperator aspect of the invention not interfering with the exhaust flow from the combustor chamber 110. Rather, after combustion, the exhaust gases are able to freely, and in an unimpeded way, flow to the air outlet 14 of the turbine, thus avoiding the increase of back pressure on the exhaust, which reduces power output, of conventional recuperators or heat exchangers. However, a turbine 10 incorporating the recuperator 100 of the present invention still achieves the benefits of preheating the air introduced into the combustor chamber 110, without the disadvantages of the heat-side heat exchanger back pressure issues presented by conventional turbine recuperators.

Although several embodiments have been described in detail for purposes of illustration, various modifications may be made without departing from the scope and spirit of the invention. Accordingly, the invention is not to be limited, except as by the appended claims.

1. A turbine recuperator, comprising:
a recuperator air flow path having an air inlet at a first end thereof upstream of a combustor chamber of a turbine, and an air outlet at a second end for delivering air into the combustor chamber, wherein at least a portion of the recuperator air flow path is disposed relative to the combustor chamber such that heat is transferred directly from the combustor chamber to at least a portion of the recuperator air flow path to pre-heat the air before entering the combustor chamber, wherein the recuperator air flow path does not interfere with an exhaust flow from the combustor chamber such that the exhaust flow is unimpeded through an exhaust outlet of the turbine.

2. The turbine recuperator of claim 1, wherein heat from the combustor chamber is conductively transferred to the air flow path.

3. The turbine recuperator of claim 1, wherein the air flow path between the air inlet and the air outlet is tortuous.

4. The turbine recuperator of claim 1, wherein the air flow path between the air inlet and the air outlet has a serpentine configuration.

5. The turbine recuperator of claim 1, wherein a wall at least partially defines the air flow path, the wall being disposed adjacent to the combustor chamber.

6. The turbine recuperator of claim 1, wherein a wall forming at least a portion of an intermediate chamber around the combustor chamber defines the air flow path.

7. The turbine recuperator of claim 1, including a plurality of projections extending into the air flow path configured as a lattice work of heat conductive material in the air flow path that facilitate heat transfer from the combustor chamber to the air flowing through the air flow path.

8. A turbine recuperator, comprising:
an air flow path formed by a wall at an air intake end of a combustor chamber of a turbine, the air flow path being tortuous and having an air inlet at a first end thereof upstream of the combustor chamber, and an outlet at a second end for delivering air into the combustor chamber, where in the wall that forms the air flow path includes a plurality of projections extending into the air flow path configured as a lattice work of heat conductive material in the air flow path, and wherein at least a portion of the wall that forms the air flow path is disposed relative to the combustor chamber such that heat is conductively transferred directly from the combustor chamber through the wall and to at least a portion of the air flow path.

9. The turbine recuperator of claim 8, wherein the air flow path between the air inlet and the air outlet has a serpentine configuration.

10. The turbine recuperator of claim 8, wherein the wall is disposed adjacent to the combustor chamber.

11. The turbine recuperator of claim 8, wherein the wall forms at least a portion of an intermediate chamber around the combustor chamber.

12. The turbine recuperator of claim 8, wherein the lattice work facilitates heat transfer from the combustor chamber to the air flowing through the air flow path.

13. A turbine recuperator, comprising:
a combustor chamber of a turbine having a wall defining an air intake air flow path, the air flow path having a serpentine configuration with an air inlet at a first end thereof upstream of the combustor chamber, and an air outlet at a second end for delivering air into the combustor chamber; and
a plurality of projections extending from the wall configured as a lattice work of conductive materials in the air flow path;
wherein heat is conductively transferred directly from the combustor chamber through the wall and the lattice work of conductive material to at least a portion of the air flow path to pre-heat the air before entering the combustor chamber.

14. The turbine recuperator of claim 13, wherein the air flow path between the air intake and the air outlet has a serpentine configuration.

15. The turbine recuperator of claim 13, wherein the wall is disposed adjacent to the combustor chamber.

16. The turbine recuperator of claim 13, wherein the wall forms at least a portion of an intermediate chamber around the combustor chamber.

17. The turbine recuperator of claim 13, wherein the air flow path does not interfere with an exhaust flow from the combustor chamber such that the exhaust flow is unimpeded through an exhaust outlet of the turbine.

18. The turbine recuperator of claim 8, wherein the air flow path does not interfere with an exhaust flow from the combustor chamber such that the exhaust flow is unimpeded through an exhaust outlet of the turbine.
